(19) United States
(12) Patent Application Publication
(10) Pub. No.: US 2025/0022314 A1
(43) Pub. Date: Jan. 16, 2025

(54) MULTIMODAL DATA-BASED METHOD AND SYSTEM FOR RECOGNIZING COGNITIVE ENGAGEMENT IN CLASSROOM

(71) Applicant: CENTRAL CHINA NORMAL UNIVERSITY, Wuhan City (CN)

(72) Inventors: Yantao WEI, Wuhan City (CN); Qi XU, Wuhan City (CN); Jie GAO, Wuhan City (CN); Qingtang LIU, Wuhan City (CN)

(73) Assignee: CENTRAL CHINA NORMAL UNIVERSITY, Wuhan City (CN)

(21) Appl. No.: 18/604,503

(22) Filed: Mar. 14, 2024

(30) Foreign Application Priority Data
Jul. 12, 2023 (CN) 2023108565023

(51) Int. Cl. G06V 40/20; G06N 3/0464; G06N 3/08; G06V 40/16; G10L 15/16

(52) U.S. Cl. CPC G06V 40/20; G06N 3/0464; G06N 3/08; G06V 40/174; G10L 15/16

(57) ABSTRACT

A method and system are introduced for recognizing cognitive engagement in classrooms by utilizing multimodal data. Associated modalities of cognitive engagement are learned from visual and audio data. This approach involves constructing a multidimensional representation model for cognitive engagement that includes behaviors, emotions, and speech. To identify engagement, three distinct deep learning models are employed: You Only Look Once version 8 (Yolov8) for analyzing body posture, Efficient Network (EfficientNet) for facial expressions, and Text Convolution Neural Network (TextCNN) for speech text. These models are trained and refined with the aid of student engagement surveys, leading to a decision-making process that integrates the results from the different modalities. Additionally, a dataset and a data annotation system are developed for engagement recognition. This innovative method aims to achieve detailed engagement recognition, addressing various perception needs in real-world applications.

### TECHNICAL FIELD

The present invention belongs to the technical domains of image recognition, image classification, text classification, and text recognition, and particularly pertains to a multimodal data-based method for recognizing cognitive engagement in classroom. The invention achieves this by integrating implicit and dynamic cues from multimodal data, offering technical support for educational applications of teaching, learning, and intervention, etc. in a natural state, and contributing to the advancement of education, enhancing accuracy and personalization.

### BACKGROUND

Deep integration of emerging information technologies such as artificial intelligence and big data with teaching and learning has promoted vigorous development of smart education. A classroom can support diversified activities and accommodate individuals with diverse backgrounds, so a classroom is a battlefield to acquire knowledge and master skills. Nevertheless, students often struggle with distractions, lack of focus, and reduced engagement in a classroom. Compounding this issue, teachers often find monitoring each student's engagement in real-time and providing timely interventions challenging, especially novice teachers who find particularly daunting. Therefore, monitoring students' learning engagement holds paramount importance as it forms a foundation for teachers to make informed decisions in class. Cognitive engagement, a fundamental aspect of learning engagement, poses a unique challenge in assessing due to its implicit and dynamic nature. Traditional assessment methods can obtain students' inner feelings but fail to capture dynamic features of cognitive engagement, and some automatic methods are not easy to use because of a rough and invasive operation. A role of enhancing assessment systems and innovating assessment tools have been emphasized in documents, including Overall Plan for Deepening the Reform of Education Assessment in the New Era, China Education Modernization 2035, and Guiding Opinions of the Ministry of Education on Strengthening the Application of the “Three Classrooms”. To address problems of intrusive and superficial assessment, we should develop an intelligent assessment technique and a well-founded framework to support a comprehensive assessment of students' cognitive engagement.

Common methods for assessing student cognitive engagement include manual observation, self-reporting, teacher ratings, experience sampling, video recording, and physiological measures, etc. Considering an implicitness of cognitive engagement, researchers usually measure through self-report, common scales include a job engagement (JES) and a student course cognitive engagement instrument (SCCEI), etc., however, manual methods like self-reporting and experience sampling etc. are not convenient to use because of the drawbacks of being time-consuming and labor-intensive. Physiological measures are commonly used in a laboratory situation, but their high invasiveness and cost limitations make implementation in a classroom challenging. A camera can capture aspects of postures, expressions, speech, and more in terms of visual and auditory cues, video recording provides convenience for collecting data in the classroom and capturing temporal features in cognitive engagement. However, video recording puts higher demands on complex interaction coding related to individual, teacher-student, and student-student interaction from a visual-auditory perspective. Therefore, it is necessary to design a methodology based on video recordings to capture implicit and dynamic cognitive engagement in classroom.

In summary, an automatic recognition of cognitive engagement in classroom is important for developing smart education. Although related studies have preliminarily explored cognitive engagement through visual clues such as facial expressions or postures, there are still difficulties in implicit concept representation, dynamic feature extraction, and multi-granularity recognition in classroom. Therefore, the present invention designs a multimodal data-based method for recognizing cognitive engagement and provides technical support for teaching adjustment in classroom.

### SUMMARY

To solve problems of implicit concept representation, dynamic feature extraction, and multi-grained recognition of cognitive engagement in classroom, the present invention designs, starting from multimodal data, a multimodal data-based method for recognizing cognitive engagement in classroom by an non-contact and non-intrusive way.

The present invention provides a multimodal data-based method for recognizing cognitive engagement in classroom. The method includes:
step 1, constructing a dataset of student cognitive engagement recognition based on multimodal data in a classroom;
step 2, constructing a multidimensional representation summary model of cognitive engagement concept based on multimodal data in a classroom;
step 3, employing three deep learning methods to recognize a cognitive behavior, a cognitive emotion, and a cognitive speech from multimodal data, and, obtaining recognition results of different modal data; and
step 4, training a model to fuse three single-modal recognition results obtained in step 3, and, obtaining a final cognitive engagement level of each student.

Further, the multimodal data in step 1 includes student's body posture, head posture, eye movement, facial expression, class audio, and speech text.

Further, step 2 links multi-modal data to a multidimensional representation of cognitive engagement in a classroom, and to determine a representation of cognitive engagement within a specific modality.

Further, one of the visual-behavioral-modal encompasses student's body posture, head posture, and eye movement, and can represent a cognitive behavior in step 3, features in a cognitive behavior are learned through a You Only Look Once version 8 (Yolov8) model.
(1) data preprocessing
standardizing the size of an input image with visual-behavioral-modal data, where the size of an input image is aligned to 640×640, and an input image is arranged in a red-green-blue (RGB) format and a channel-height-width (CHW) format;
(2) backbone layer
extracting features from visual-behavioral-modal data, first, reducing resolution by four times by continuously using two 3×3 convolutions, where the number of convolution channels is 64 and 128, respectively, and then, enriching gradient flow with a cross-stage partial feature fusion (c2f) module using branch cross-layer linking;
(3) neck layer and head layer
feeding output visual-behavioral features from different stages of a backbone layer into up-sampling, then, combining feature maps through a decoupling head and an anchor-free mechanism, next, a convolution calculation are performed on feature maps; and
(4) target detection loss calculation
using a loss calculation with a positive-negative sample allocation strategy and a combined loss calculation, a positive-negative sample allocation strategy is to select a positive sample t according to weights of classification and regression by a task alignment strategy, a calculation is as follows:

$$t = {s}^{α} \times {u}^{β} \qquad ( 1 )$$

where sα is a predicted value with a parameter a corresponding to an annotated class, uβ is calculated as follows:

$$\text{?} = \frac{Y ⋂ \hat{Y}}{Y ⋃ \hat{Y}} \qquad ( 2 )$$

$$\text{?} \text{indicates text missing or illegible when filed}$$

where Y indicates an actual behavior annotation box of students, Ŷ indicates a predictive behavior annotation box Y of students, a combined loss calculation includes a classification (CLS) loss and a regression loss, a CLS loss uses a binary cross entropy (BCE) loss calculation mode, a regression loss uses a distribution focal loss (DFL) calculation mode and a complete intersection over union (CIoU) loss (CIL) calculation mode, and, three losses are weighted by a certain proportion to obtain a final loss;
1) a CLS value is calculated as follows:

$$CLS = - \frac{1}{M} {\sum }_{i = 1}^{M} ( {Y}_{i} log ( {\hat{Y}}_{i} ) + ( 1 - {Y}_{i} ) log ( 1 - {\hat{Y}}_{i} ) ) \qquad ( 3 )$$

where M indicates the number of students in a classroom, Yi is an actual behavior annotation box of an i-th student, Ŷi is a predictive behavior annotation box of an i-th student;
2) a DFL value and a CIL value are calculated as follows:

$$D F L ( {S}_{i} , {S}_{i + 1} ) = - ( ( {Y}_{i + 1} - Y ) log ( {S}_{i} ) + ( Y - {Y}_{i} ) log ( {S}_{i + 1} ) ) \qquad ( 4 )$$

$$CIL = 1 - ( {u}^{β} - ( loss ( length ) + loss ( width ) ) ) \qquad ( 5 )$$

where Si indicates a softmax activation function calculation on features of an i-th student, new features are converted into a probability distribution with a range of [0,1] and 1, loss (length) indicates a loss of a predictive behavior annotation box Ŷ and an actual behavior annotation box Y of students in length, loss (width) indicates a loss of a predictive behavior annotation box Ŷ and an actual behavior annotation box Y of students in width; and
3) defining a final loss, a CLS value, a DFL value and a CIL value of three losses are fused as follows:

$$L = {λ}_{1} \cdot CLS + {λ}_{2} \cdot DFL + {λ}_{3} \cdot CIL \qquad ( 6 )$$

where λ1, λ2, and λ3 are three fusion weights, respectively, with a range of [0, 1].

Further, one of the visual-emotional-modal encompasses student's facial expression etc., and can represent a cognitive emotion in step 3, features in a cognitive emotion are learned through an Efficient Network (EfficientNet) model to determine a cognitive emotion engagement, 9 calculation stages are provided as follows:
(1) stage 1: obtaining shallow features of a visual-emotional-modal using a regular convolution calculation with a convolution kernel of 3*3 and a stride of 2;
(2) stages 2 to 8: outputting deep features by repeating a stacked mobile inverted bottleneck convolution (MBConv), MBConv structure mainly expands a dimension of shallow features by a 1*1 regular convolution, the number of convolution kernels is p times of input feature channels, p∈{1,6}; then, continuing to extract facial key features by a q*q depthwise convolution (Conv) (where q=3 or 5) and a squeeze-and-excitation (SE) module; next, reducing a dimension of feature maps with facial key features through a 1*1 regular convolution; finally, generating new feature maps by a dropout layer to prevent overfitting; and
(3) stage 9: outputting cognitive emotion engagement by a composition of a regular convolution layer, a maximum pooling layer, and a fully connected layer.

Further, an audio-verbal-modal encompasses student's class audio and speech text, and can represent a cognitive speech in step 3, features in a cognitive speech are learned through a Text Convolution Neural Network (TextCNN) model to determine a cognitive speech engagement, specific process is as follows;
(1) the first layer: an input is an n*k matrix, n is the number of words in a sentence, k is a word vector dimension corresponding to each word, each row of an input layer is a k-dimensional word vector corresponding to a word;
(2) the second layer: a regular convolution is used on an input matrix, a convolution kernel is set as w∈Rkk, an output is c, c is calculated as follows:

$$c = input w \qquad ( 7 )$$

where ⊗ indicates a regular convolution operation, c=[c1, c2, . . . , cn−h+1] indicates a new word feature vector extracted by a regular convolution, c1, c2, . . . , cn−h+1 indicate feature vectors of a first sentence s1, a second sentence s2, . . . of student's speech until the last speech sentence during a class, a feature vector ci of each sentence is calculated as follows:

$${c}_{i} = f ( w \cdot {x}_{i : i + h - 1} + b ) \qquad ( 8 )$$

where xi: i+h−1 indicates a window with a size of h*k formed by an i-th row to an i+h−1 row of an input matrix, it is formed by splicing xi, xi+1, . . . , xi+h−1, b is a bias parameter, f is a nonlinear activation function;
(3) the third layer: a maximum pooling, a K-Max pooling, or an average pooling is used to screen a new text feature vector output by the second layer, a maximum pooling screens the largest feature from features generated by each sliding window, and splices features to form a vector representation; a K-Max pooling selects the largest K features in audio-features; an average pooling averages each dimension in audio-features; then, a fixed-length vector representation is obtained by pooling different lengths of sentences; and
(4) the fourth layer: a fully connected layer and an output layer are used to connect all audio-features and classify speech of a student, then, each class probability of a speech is outputted by a softmax activation function.

Further, a multidimensional representation summary model of cognitive engagement concept in classroom is constructed from three dimensions: cognitive behavior, cognitive emotion, and cognitive speech, specific construction steps are as follows:
(1) representing a cognitive behavior of cognitive engagement in a classroom by a visual-behavioral-modal encompassing body posture etc., for a video frame at time f, vectorizing an image corresponding to a moment; then, representing each pixel point of a whole image with a numerical value of [0,9] as a representation result A of visual-modal encompassing body posture etc.;
(2) representing a cognitive emotion of cognitive engagement in a classroom by a visual-emotional-modal encompassing facial expression, for a video frame at time f, automatically extracting face images using an Open source Computer Vision (OpenCV) library, we use extracted images as a foundation for cognitive emotion at time f; then, representing each pixel point of a face image with a numerical value of [0,9] to form a representation result B of visual-modal encompassing facial expression etc.; and
(3) representing a cognitive speech of cognitive engagement in a classroom by an audio-verbal-modal encompassing class audio etc., jointly representing cognitive speech by two ways of a pre-trained word vector and a word vector with parameters, a representation result is C.

Further, in step 1, constructing a dataset of cognitive engagement recognition based on multimodal data in a classroom, specific implementation is as follows;
(1) in a classroom environment, led by a teacher who imparts instruction naturally, there are multiple students participating in activities and knowledge construction, a teacher is allowed to fuse advanced technology tools and teaching modes to carry out different class activities;
(2) recording students learning state in a non-invasive and non-perceptive manner, first, mounting a high-definition camera in front of a classroom, then, we open a camera before a class and close it after a class to record a class learning situation in real-time, and then, export recording data from a terminal system as a foundation of a cognitive engagement recognition;
(3) developing a data annotation system to guide manual annotation, during multimodal data annotation, cognitive behavior is annotated using visual-behavioral-modal data with body postures etc., cognitive emotion is annotated using visual-emotional-modal data with facial expression etc., and cognitive speech is annotated using audio-verbal-modal data with class audio etc., a data annotation system is detailed in FIG. 2.
(4) simultaneously annotating part of the recording data by multiple annotators, carrying out a consultation on inconsistent places, and, annotating the recording data on a large scale;
(5) employing an after-class questionnaire to acquire a genuine cognitive engagement, we use a Likert five-point scoring method as a guidance of multimodal fusion training; and
(6) extracting many video frames to obtain student cognitive engagement state at different granularities, a frame extraction rate is every 25, 50, . . . , or 25*f (f is an integer) frames/time, this condition aligns with a video frame rate of 25 fps, a frame extraction rate is configured to train deep learning models for cognitive engagement.

Further, in step 4, a final cognitive engagement level of a student is achieved by following methods:
(1) assuming that three engagement vectors of an i-th student recognized at a moment j are Âj∈Rn1, \hat{B}j∈Rn2 and Ĉj∈Rn3 respectively, Âj is a cognitive behavior engagement. \hat{B}j is a cognitive emotion engagement, Ĉj is a cognitive speech engagement, n1, n2 and n3 indicate feature vectors of three dimensions respectively;
(2) given an educational activity, assuming that F times of real-time engagement recognitions are provided in total in a whole activity, training models of three cognitive engagement states separately, then, calculating Âj, \hat{B}j, and Ĉj by deep learning models; and
(3) training a decision-making model to recognize a cognitive engagement level Engagementj of a j-th student at a moment i according to surveys, it is calculated as follows:

$${Engagement}_{j} = {β}_{1} \cdot {\hat{A}}_{j} + {β}_{2} \cdot {\hat{B}}_{j} + {β}_{3} \cdot {\hat{C}}_{j} \qquad ( 5 )$$

where β₁, β₂, and β₃ are three parameters to be learned.

The present invention further provides a multimodal data-based system for recognizing cognitive engagement in classroom, a system includes:
a dataset construction module configured to construct a dataset of student cognitive engagement recognition based on multi-modal data in classroom;
a multidimensional representation module configured to obtain three dimensional representation of cognitive engagement concept in classroom;
a multimodal recognition module configured to recognize cognitive behavior, cognitive emotion, and cognitive speech through three deep learning models based on different modal data respectively, then, output three engagement recognition results; and
a result fusion module configured to fuse three results of different modalities, weights of different modalities are adjusted, and then a decision-making method with weights of cognitive engagement guided by the surveys is trained to output an overall level of cognitive engagement.

Compared with existing inventions, the present invention has the beneficial effects:
1. the present invention introduces a multimodal, multidimensional, fine-grained calculation method for cognitive engagement assessment. The invention uses pedagogy and psychology theories, then cognitive engagement is divided into a cognitive behavior, a cognitive emotion and a cognitive speech, and the present invention can fulfill multi-dimensional perception demands of cognitive engagement during class, which lies a foundation for a nuanced perception of cognitive engagement;
2. the present invention solves the problems of automatic recognition of cognitive engagement of different modalities by means of three distinct classes of deep learning models, these include a Yolov8 model based on body postures etc., an EfficientNet model based on facial expressions etc, and a TextCNN model based on speech texts etc., the invention enhances the learning capability of a recognition model by incorporating implicit dynamic features, and the present invention makes it convenient for practical application in actual classroom; and
3. the present invention establishes a fine-grained method for recognizing cognitive engagement by fusing multimodal data in classroom, this invention is informed by feedback gathered from surveys, and then, adaptively adjusts a contribution of different modals to a final cognitive engagement level so as to meet the multi-level and multi-stage perception demands in actual classroom application.

### BRIEF DESCRIPTION OF THE DRAWINGS

FIG. 1 is a diagram of a multimodal data-driven representation summary model of cognitive engagement in classroom;

FIG. 2 is a diagram of a data annotation system of cognitive engagement in classroom;

FIG. 3 is a structural diagram of a You Only Look Once version 8 (Yolov8) model based on student's body posture etc.;

FIG. 4 is a structural diagram of an Efficient Network (EfficientNet) model based on student's facial expression etc.;

FIG. 5 is a structural diagram of a Text Convolution Neural Network (TextCNN) model based on student's speech text etc.;

FIG. 6 is a flow chart of a student cognitive engagement recognition in a classroom in a nature-oriented state;

FIG. 7 is a diagram of a training result of a Yolov8 model based on student's body posture etc.;

FIG. 8 is a diagram of a training result of an EfficientNet model based on student's facial expression etc.; and

FIG. 9 is a diagram of a training result of a TextCNN model based on student's speech text etc.

### DETAILED DESCRIPTION OF THE EMBODIMENTS

The technical solutions of the present invention will be further described in detail below with reference to the accompanying drawings.

The present invention provides a multimodal data-based method for recognizing cognitive engagement in classroom. The method includes:
step 1, construct a dataset of student cognitive engagement recognition based on multimodal data in a classroom;
step 2, construct a multidimensional representation summary model of cognitive engagement based on multimodal data in a classroom;
step 3, employ three deep learning methods to recognize a cognitive behavior, a cognitive emotion, and a cognitive speech from multimodal data, and, obtain recognition results of different modal data; and
step 4, train a model to fuse three single-modal recognition results obtained in step 3, and, obtain a final cognitive engagement level of each student.

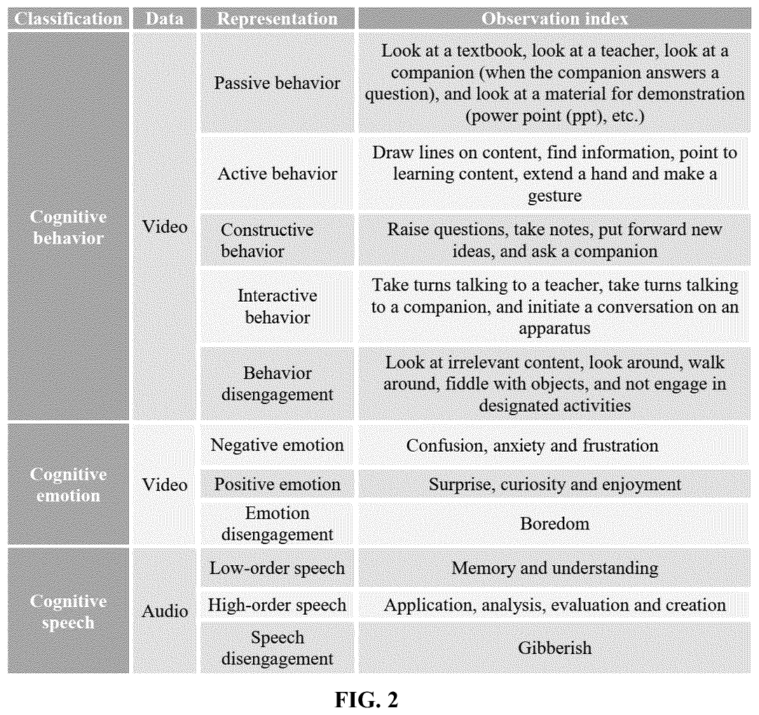

The step of constructing a dataset of student cognitive engagement recognition in classroom based on multimodal data specifically includes:
(1) in a classroom environment, in a case of being led by a teacher who imparts instruction naturally and multiple students participating in activities and knowledge construction, allow a teacher to fuse advanced technology tools and teaching modes to carry out different class activities;
(2) record students' learning state in a non-invasive and non-perceptive manner, first, mount a high-definition camera in front of a classroom, then, open a camera before a class and close it after a class to record a class learning situation in real-time, and then, export recording data from a terminal system as a foundation of a cognitive engagement recognition;
(3) develop a data annotation system to guide manual annotation, where cognitive behavior is annotated using visual-modal data with body postures etc., cognitive emotion is annotated using visual-modal data with facial expressions etc., and cognitive speech is annotated using class audio-modal data with class audio etc., a data annotation system is detailed in FIG. 2;
(4) simultaneously annotate part of the recordings by multiple annotators, and carry out consultation on inconsistent places, and annotate the recordings on a large scale;
(5) employ an after-class questionnaire to acquire a genuine cognitive engagement, and use a Likert five-point scoring method as a guidance of multimodal fusion training; and
(6) extract many video frames to obtain students cognitive engagement at different granularities, a frame extraction rate is every 25, 50, . . . , or 25*f (f is an integer) frames/time, this condition aligns with a video frame rate of 25 fps, a frame extraction rate is configured to train three deep learning models for cognitive engagement.

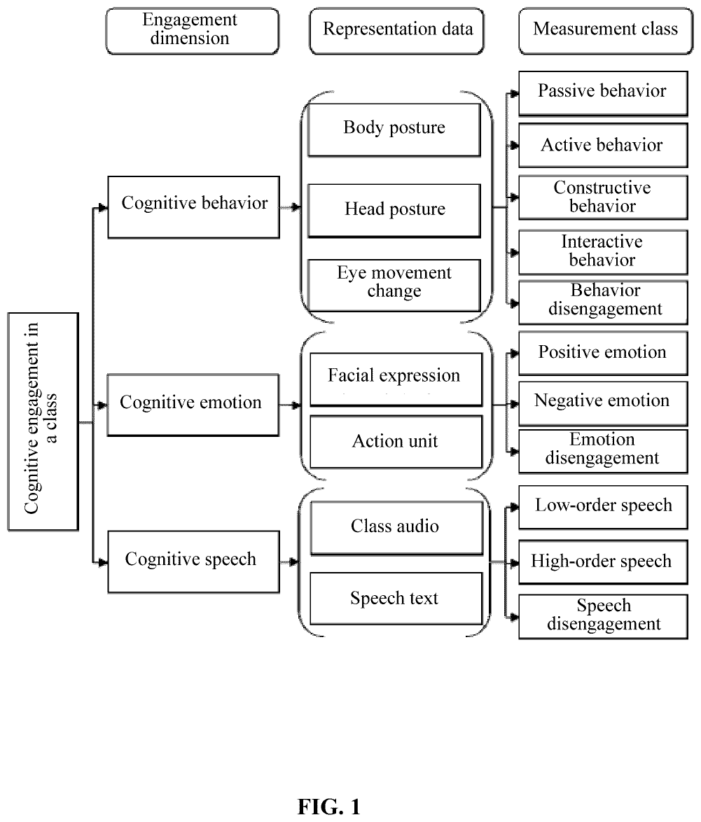

Further, multimodal data in the present invention includes body posture, head posture, eye movement, facial expression, class audio, and speech text, dimensions of cognitive engagement are a cognitive behavior, a cognitive emotion, and a cognitive speech, as shown in FIG. 1, specific construction steps of a multidimensional representation summary model of cognitive engagement concept in classroom are as follows;
(1) represent a cognitive behavior of cognitive engagement in a classroom by a visual-behavioral-modal encompassing student's body posture etc., for a video frame at a moment f, vectorize a whole image, then, represent each pixel point in an image by a number of [0, 9], because an image consists of three color channels—red, green and blue (RGB), pixels points of three channels are all represented of visual-behavioral-modal data, a representation mode A is as follows:

$$A = {\sum }_{f = 1 , i = 1}^{F , M} {a}_{fi} \qquad ( 6 )$$

where afi indicates a cognitive behavior feature matrix of an i-th student at a moment f, I has a value range of [1, M], M indicates the number of students in a classroom, F indicates the total number of frames extracted from a class video;
(2) represent a cognitive emotion of cognitive engagement in a classroom by a visual-emotional-modal encompassing student's facial expression etc., for a video frame at a moment f, automatically extract face images by an Open source Computer Vision (OpenCV) library, then, use an extracted image as a foundation for cognitive emotion, next, represent each pixel point of a face image by a number of [0, 9], finally, form a representation result B as follows:

$$B = {\sum }_{f = 1 , i = 1}^{F , M} {b}_{fi} \qquad ( 7 )$$

where bfi indicates a cognitive emotion feature matrix of a i-th student at a moment f, bfi is a subset of afi; and
(3) represent a cognitive speech of cognitive engagement in a classroom by an audio-verbal-modal encompassing student's class audio etc., represent a cognitive speech by two ways of a pre-trained word vector and a word vector with parameters, a representation mode is as follows:

$$C = {μ}_{1} \cdot {\sum }_{f = 1 , i = 1}^{F , M} {c}_{fi} + {μ}_{2} \cdot {\sum }_{f = 1 , i = 1}^{F , M} μ {c}_{fi} \qquad ( 8 )$$

where

$${\sum }_{f = 1 , i = 1}^{F , M} {c}_{fi}$$

indicates a cognitive speech feature vector of an i-th student at a moment f,

$${\sum }_{f = 1 , i = 1}^{F , M} μ {c}_{fi}$$

indicates a feature word vector with a parameter u of a cognitive speech of an i-th student at a moment f.

Further, carry out a multimodal recognition of cognitive engagement by three methods, multimodal data includes body posture, head posture, eye movement, facial expression, class audio, and speech text.

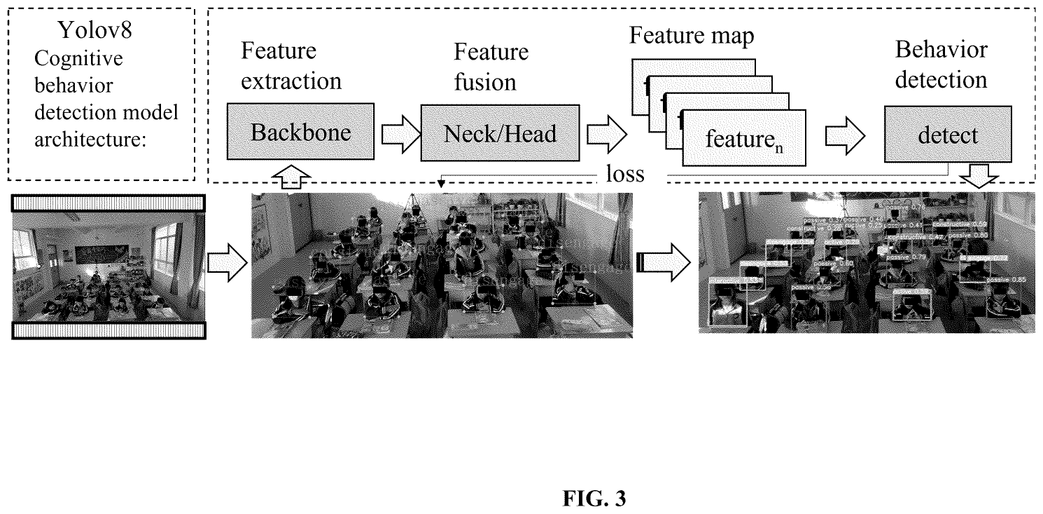

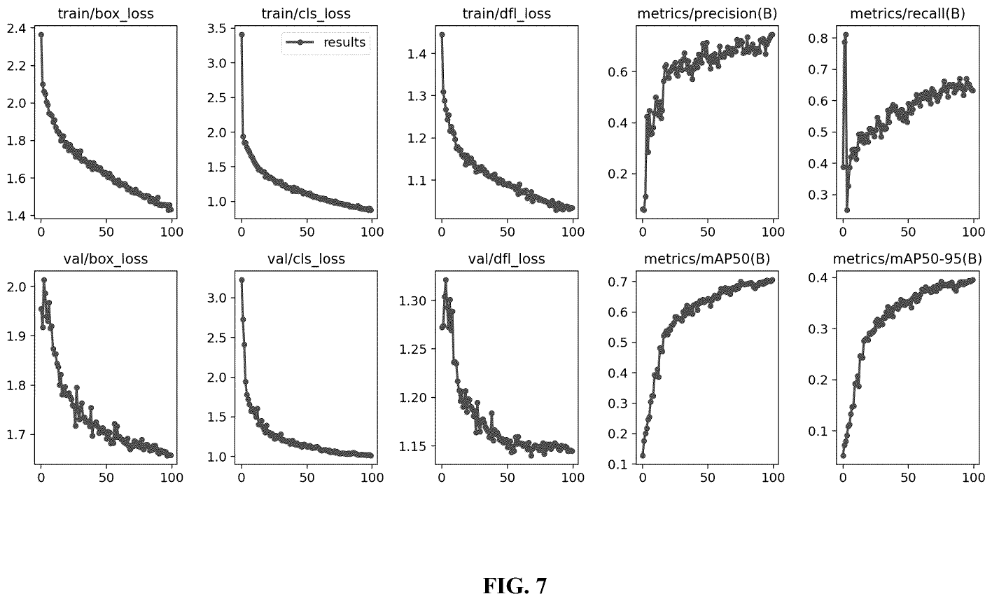

Further, calculation methods for visual-behavioral-modal data of student's body posture etc. are as follows:
an input for a cognitive behavior is represented as A, using a You Only Look Once version 8 (Yolov8) model on A, as shown in FIG. 3, features in this modal are learned to determine a cognitive behavior engagement, in order to further verify the effectiveness of a Yolov8 model, relevant experiments have been carried out on a self-built dataset, training results are shown in FIG. 7, the recognition performance of a passive behavior is optimal.
(1) data preprocessing
adjust representation A of visual-behavioral-modal data is essential to align A with the input format of a Yolov8 model, standardize an input image by aligning the size of an input image to 640×640, and, arrange an input image is in a RGB format and a channel-height-width (CHW) format;
(2) backbone layer
extract features from visual-behavioral-modal data, reducing resolution by four times by continuously using two 3×3 convolutions, the number of convolution channels is 64 and 128, respectively, then, enrich gradient flow with a cross-stage partial feature fusion (c2f) module by branch cross-layer linking;
(3) neck layer and head layer
feed output visual-behavioral features from different stages of a backbone layer into up-sampling, then, combine visual-behavioral feature maps through a decoupling head and an anchor-free mechanism, next, a convolution calculation are performed on visual-behavioral feature maps; and
(4) target detection loss calculation
use a loss calculation including a positive-negative sample allocation strategy and a combined loss calculation, a positive-negative sample allocation strategy is to select a positive sample t according to weights of a classification and a regression by a task alignment strategy, a calculation is as follows:

$$t = {s}^{α} \times {u}^{β} \qquad ( 9 )$$

where sα is a predicted value with a parameter a corresponding to an annotated class, uβ is calculated as follows:

$${u}^{β} = \frac{Y ⋂ \hat{Y}}{Y ⋃ \hat{Y}} \qquad ( 10 )$$

where Y indicates an actual behavior annotation box of all students, Ŷ indicates a predictive behavior annotation box of all students, a combined loss calculation includes a classification (CLS) loss and a regression loss, a CLS loss uses a binary cross entropy (BCE) loss calculation mode, a regression loss uses a distribution focal loss (DFL) calculation mode and a complete intersection over union (CIoU) loss (CIL) calculation mode, finally, three losses are weighted by a certain proportion to obtain a final loss;
1) a CLS value is calculated as follows:

$$CLS = - \frac{1}{M} {\sum }_{i = 1}^{M} ( {Y}_{i} log ( {\hat{Y}}_{i} ) + ( 1 - {Y}_{i} ) log ( 1 - {\hat{Y}}_{i} ) ) \qquad ( 11 )$$

where M indicates the number of students in a classroom; Yi is an actual behavior annotation box of an i-th student; Ŷi is a predictive behavior annotation box of an i-th student;
2) a DFL value and a CIL value are calculated as follows:

$$D F L ( {S}_{i} , {S}_{i + 1} ) = - ( ( {Y}_{i + 1} - Y ) log ( {S}_{i} ) + ( Y - {Y}_{i} ) log ( {S}_{i + 1} ) ) \qquad ( 12 )$$

$$CIL = 1 - ( {u}^{β} - ( loss ( length ) + loss ( width ) ) ) \qquad ( 13 )$$

where Si indicates a softmax activation function calculation on features of an i-th student; new modal features are converted into a probability distribution with a range of [0, 1] and 1, loss (length) indicates a loss of a predictive behavior annotation box Ŷ and an actual behavior annotation box Y of students in length, loss (width) indicates a loss of a predictive behavior annotation box Ŷ and an actual behavior annotation box Y of students in width; and
3) define a final loss, a CLS value, a DFL value and a CIL value of three classes of losses are fused as follows:

$$L = {λ}_{1} \cdot ( CLS + {λ}_{2} \cdot DFL + {λ}_{3} \cdot CIL \qquad ( 14 )$$

where λ1, λ2 and λ3 are three fusion weights respectively, they have a range of [0, 1].

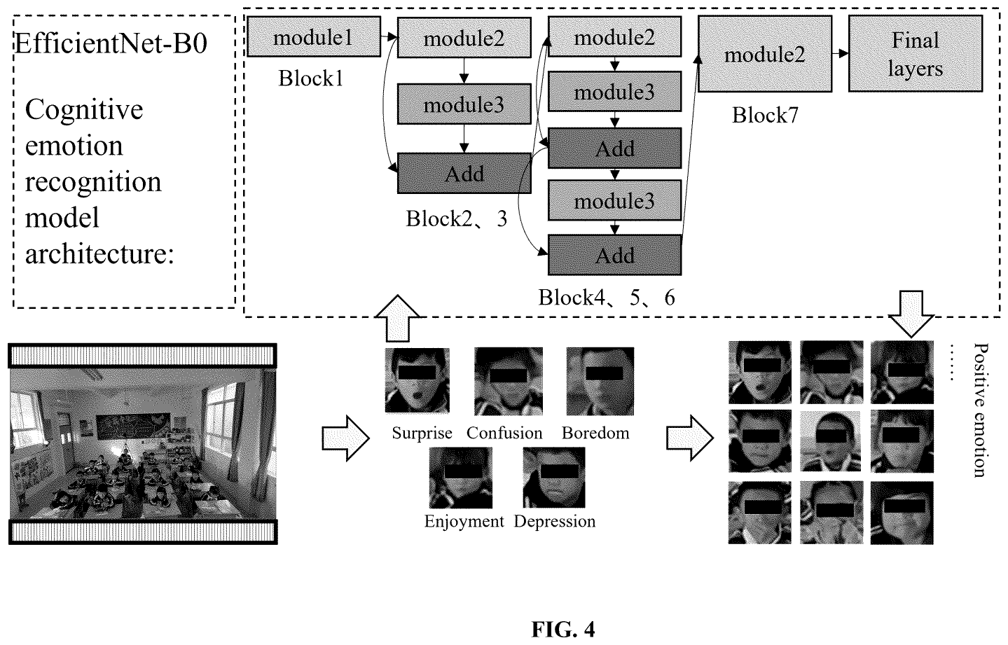

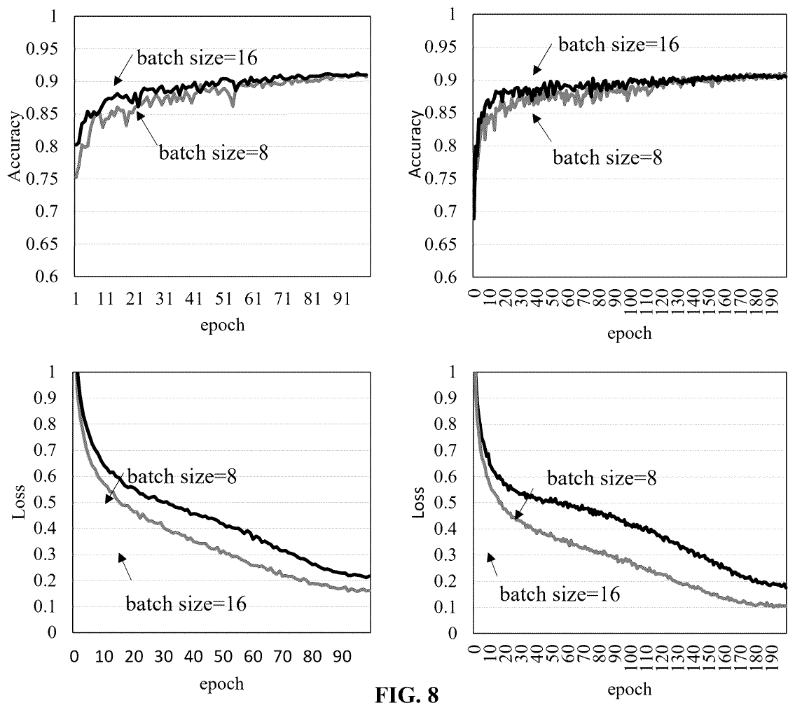

Further, calculation methods for visual-emotional-modal data of student's facial expression etc. are as follows:
an input is a representation B of a cognitive emotion, using an efficient network (EfficientNet) model on B, As shown in FIG. 4, features are learned to determine a cognitive emotion engagement mapped by visual-emotional-modal, in order to further verify effectiveness of EfficientNet model on B, relevant experiments have been carried out on a self-built dataset, training results shown in FIG. 8 are obtained by setting different hyper-parameters, the recognition accuracy of cognitive emotion reaches 91%, B of a cognitive emotion dimension is key information extracted from a face image, we set B to accord with an input format of an EfficientNet model, the image size of B is aligned to 224*224, and an image is set as a RGB and a CHW format, then, 9 calculation stages are executed as follows:
(1) stage 1: obtain shallow features FACES of visual-emotional-modal data by a convolution kernel w′ (with a size of 3*3 and a stride of 2) and a representation of a cognitive emotion dimension into B through a regular convolution calculation ⊗:

$$FACES = w ' ⊗ B \qquad ( 15 )$$

(2) stages 2 to 8: as shown in FIG. 3 of a block1 to a block7, these blocks are core modules of feature calculation, output facial deep features FACES' of shallow features by repeating a stacked mobile inverted bottleneck convolution (MBConv):

$$FACES ' = MBConv ◦ \cdot FACES \qquad ( 16 )$$

where ⊚ is a feature calculation mode of MBConv structure, MBConv structure mainly expands a dimension (which corresponds to module1 in FIG. 3) of shallow features by means of a 1*1 regular convolution, the number of convolution kernels is p times of channels of an input feature matrix, p∈{1,6}, then, continue to extract facial key features (which corresponds to module2 in FIG. 4) by a q*q depthwise convolution (Conv) (where q=3 or 5) and a squeeze-and-excitation (SE) module, then, a dimension of facial key features is reduced by a 1*1 regular convolution (which corresponds to module3 in FIG. 4), finally, new feature maps are generated by a dropout layer, serving as a preventive measure against overfit; and
(3) stage 9: output cognitive emotion engagement \hat{B}j mapped at a moment j by means of a composition (which corresponds to final layer module in FIG. 4) of a regular convolution layer, a maximum pooling layer and a fully connected layer;

$${\hat{B}}_{j} = fc ( pool ( \overline{w} ⊗ FACES ' + b ) ) \qquad ( 17 )$$

where pool( ) indicates a pooling calculation, fc( ) indicates a fully connected calculation, b indicates a deviations to be trained.

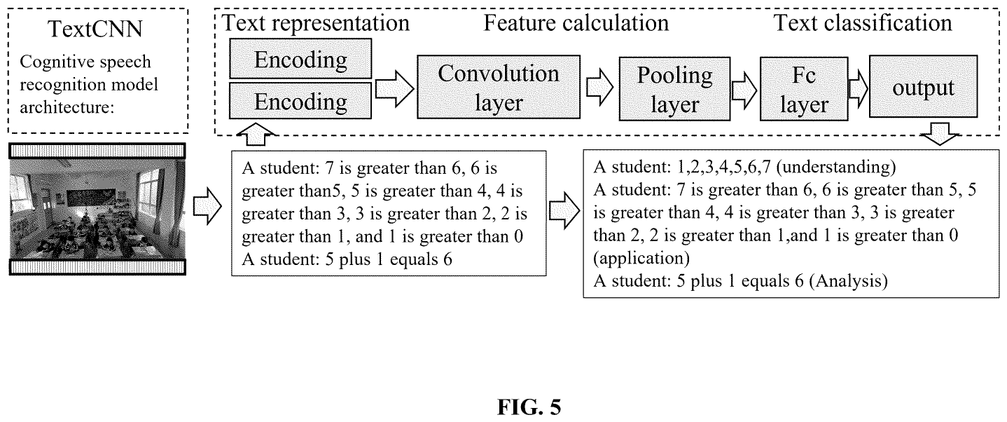

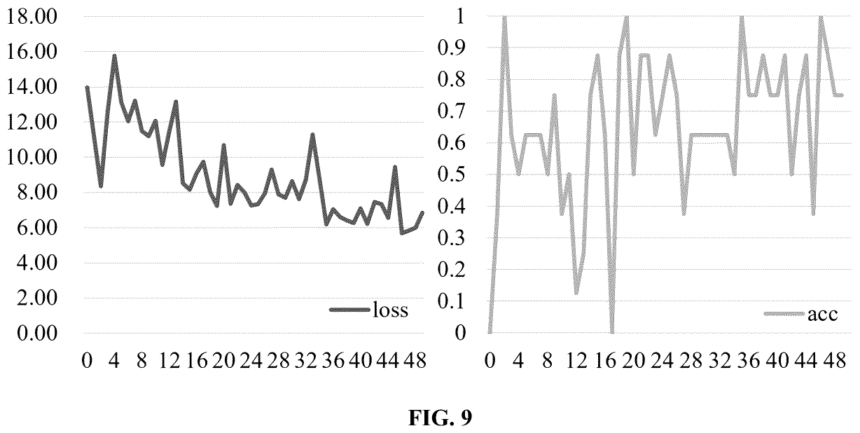

Further, calculation methods for audio-verbal-modal data encompassing student's class audio etc. are as follows:
an input is a representation C of a cognitive speech dimension, using a text convolution neural network (TextCNN) model on C, as shown in FIG. 5, features are learned to determine a cognitive speech engagement mapped by this modal, in order to verify effectiveness of a TextCNN model on C, some experiments have been carried out on a self-built dataset, training results by setting epochs as 50 are shown in FIG. 9.
(1) the first layer is an input layer (it is a encoding module in FIG. 5): an input is an n*k matrix, n is the number of words in a sentence, k is a dimension corresponding to each word, each row of an input layer is a k-dimensional word vector corresponding to a word, each word vector is C of cognitive speech input dimension, may be pre-trained in other corpora or trained as parameters by networks, herein, a dual channel form is used, that is, a representation C of a cognitive speech dimension has two input matrices—a pre-trained word vector and a word vector with parameters;
(2) the second layer is a convolution layer (which corresponds to a convolution layer module in FIG. 5): a regular convolution calculation is used on an input matrix, a convolution kernel is set as w∈Rkk, an output of this layer is c, c is calculated as follows:

$$c = input ⊗ w \qquad ( 18 )$$

where ⊗ indicates a regular convolution calculation, c=[c1, c2, . . . , cn−h+1] indicates a new word feature vector extracted by a convolution layer, c1, c2, . . . , cn−h+1 indicate feature vectors of a first sentence s1, a second sentence s2, . . . of students' cognitive speech until the last speech sentence during class, a feature vector ci is calculated as follows:

$$\begin{matrix}{c}_{i} = f & ( w \cdot {x}_{i : i + h - 1} + b )\end{matrix} \qquad ( 19 )$$

where xi: i+h−1 indicates a window with a size of h*k formed by an i-th row to an i+h−1 row of an input matrix, it is formed by splicing xi, xi+1, . . . , xi+h−1, b is a bias parameter, f is a nonlinear activation function;
(3) the third layer is a pooling layer (which corresponds to a pooling layer module in FIG. 5): select a maximum pooling, a K-Max pooling, or an average pooling to screen a new text feature vector Vec output by the second layer, a maximum pooling screens the largest feature from feature vectors generated by each sliding window, and then splice features to form a vector representation, a K-Max pooling selects the largest K features in feature vectors, an average pooling averages each dimension in a feature vector, so different lengths of sentences are pooled to obtain a fixed-length vector representation as follows:

$$Vec = pool ( c ) \qquad ( 20 )$$

(4) the fourth layer is a fully connected layer and a text classification output (which correspond to a Fc layer module and an output module in FIG. 5): splice all features by a fully connected calculation, a probability of each speech class is output through a softmax activation function, which is denoted as Ĉj:

$${\hat{C}}_{j} = Soft max ( f c ( V e c ) ) \qquad ( 21 )$$

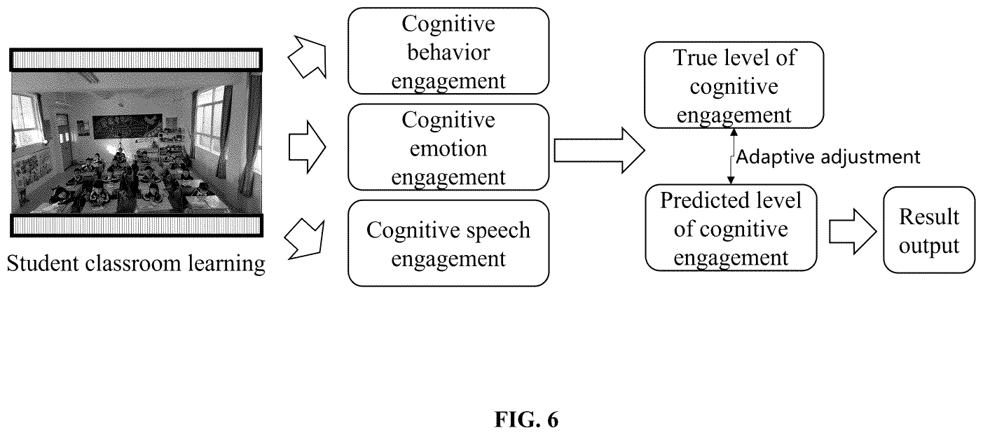

as shown in FIG. 6, guided by the student cognitive engagement surveys, three recognition results for a cognitive behavior, a cognitive emotion, and a cognitive speech are fused through a decision-making fusion for determining a final cognitive engagement level of a student, specific steps include:
(1) assume that three engagement vectors of an i-th student recognized at a moment j are Âj∈Rn1, \hat{B}j∈Rn2 and Ĉj∈Rn3 respectively, Âj is a cognitive behavior engagement, \hat{B}j is a cognitive emotion engagement, Ĉj indicates a cognitive speech engagement, n1, n2 and n3 indicate three feature vectors of three dimensions respectively;
(2) given an educational activity, assume that F times of real-time engagement recognitions are provided in total in a whole activity, and train recognition networks of three cognitive engagement states separately, then, a cognitive behavior engagement Âj (passive behavior, active behavior, constructive behavior, interactive behavior, or behavior disengage), a cognitive emotion engagement \hat{B}j (positive emotion, negative emotion, or emotion disengage), and a cognitive speech engagement Ĉj (low-order speech, high-order speech, or speech disengage) are calculated by three kinds of deep learning models; and
(3) according to three recognized cognitive engagement results, an overall cognitive engagement level Engagementj (low engagement, middle engagement, or high engagement) are calculated as follows:

$${Engagement}_{j} = {β}_{1} \cdot {\hat{A}}_{j} + {β}_{2} \cdot {\hat{B}}_{j} + {β}_{3} \cdot {\hat{C}}_{j} \qquad ( 22 )$$

where Engagementj is a joint perceived cognitive engagement of a j-th student at a moment i, Engagementj∈{0,1,2}, β1, β2 and β3 are three parameters with a range of [0, 1].

Likewise, a more reliable cognitive engagement level can be assessed on a spectrum ranging from fine-grained to coarse-grained, enabling the recognition of cognitive engagement at various levels and learning stages, on this basis, first, carry out classroom data collection of cognitive engagement in a primary school, and, apply a representation model and a data annotation system to a multimodal dataset, experimental results are shown in Table 1, the proposed method obtains excellent recognition results on indexes of P, R, and F1, etc., such that the effectiveness of the above method is verified, in the future, the scale of the dataset will be further expanded, and different classes of weights will be fused to improve the model's generalization, our method holds significant application potential in understanding students' learning states and optimizing classroom instruction in classroom environments.

TABLE 1
Recognition results of cognitive engagement in classroom

| Measurement | | Evaluation | Sub- | | | F1 |
|---|---|---|---|---|---|---|
| object | Dimension | model | dimension | Precision P | Recall R | score |
| Cognitive | Cognitive | YOLOv8 | Passive | 0.775 | 0.79 | 0.782 |
| engagement | behavior | model | behavior | | | |
| | | | Active | 0.568 | 0.568 | 0.568 |
| | | | behavior | | | |
| | | | Constructive | 0.719 | 0.697 | 0.708 |
| | | | behavior | | | |
| | | | Interactive | 0.942 | 0.615 | 0.779 |
| | | | behavior | | | |
| | | | Behavior | 0.663 | 0.489 | 0.576 |
| | | | disengagement | | | |
| | Cognitive | EfficientNet | Positive | 0.962 | 0.963 | 0.962 |
| | emotion | model | emotion | | | |
| | | | Negative | 0.918 | 0.919 | 0.918 |
| | | | emotion | | | |
| | | | Emotion | 0.865 | 0.875 | 0.870 |
| | | | disengagement | | | |
| | Cognitive | TextCNN | Low-order | 0.60 | 0.75 | 0.68 |
| | speech | model | speech | | | |
| | | | High-order | 0.50 | 0.33 | 0.42 |
| | | | speech | | | |
| | | | Speech | 0.99 | 0.99 | 0.99 |
| | | | disengagement | | | |

The present invention further provides a multimodal data-based system for recognizing cognitive engagement in classroom, a system includes:
a dataset construction module configured to construct a dataset of student cognitive engagement in classroom from a perspective of multimodal data in classroom;
a multidimensional representation module configured to obtain three dimensional representation of cognitive engagement concept in classroom;
a multimodal recognition module configured to recognize cognitive behavior, cognitive emotion, and cognitive speech through three deep learning methods based on multimodal data respectively, then, output three engagement results; and
a result fusion module configured to fuse three results of different modalities, weights of different modalities are adjusted, and then a decision-making method with weights of cognitive engagements guided by the surveys is trained to output a final level of a student cognitive engagement, a particular embodiment of each module is the same as each step, which is not described in the present invention.

The provided examples are intended to illustrate the essence of the present invention, those experienced in the relevant fields have the flexibility to introduce various modifications (or supplements to the described specific examples or substitute them with similar methods), all while remaining within the spirit of the present invention and falling within the scope defined by the appended claims.

What is claimed is:

1. A multimodal data-based method for recognizing cognitive engagement in classroom, comprising:
step 1, constructing a dataset of student cognitive engagement recognition based on multimodal data in a classroom;
step 2, constructing a multidimensional representation summary model of cognitive engagement concept based on multimodal data in a classroom;
step 3, employing three deep learning methods to recognize a cognitive behavior, a cognitive emotion, and a cognitive speech from multimodal data, and, obtaining three recognition results of different modal data; and
step 4, training a model to fuse three single-modal recognition results obtained in step 3,and, obtaining a final cognitive engagement level of each student.

2. The multimodal data-based method for recognizing cognitive engagement in classroom according to claim 1, wherein in step 2, multimodal data comprises body posture, head posture, eye movement, facial expression, class audio, and speech text.

3. The multimodal data-based method for recognizing cognitive engagement in classroom according to claim 1, wherein in step 2, a multidimensional representation summary model of cognitive engagement concept in classroom is constructed from three dimensions of cognitive behavior, cognitive emotion, and cognitive speech, specific construction steps are as follows:
(1) representing a cognitive behavior of cognitive engagement in a classroom by visual-behavioral-modal data encompassing student's body postures etc., for a video frame during class at time f, vectorizing an image corresponding to a moment, then, representing each pixel point of a whole image with a value of [0,9] as a representation result A of visual-modal encompassing body posture etc.;
(2) representing a cognitive emotion of cognitive engagement in a classroom by visual-emotional-modal encompassing student's facial expressions etc., for a class video frame at time f, automatically extracting face images using an Open source Computer Vision (OpenCV) library, using extracted face images as the foundation for cognitive emotion at time f, then, representing each pixel point of a face image with a value of [0,9] to form a representation result B of visual-modal encompassing facial expression etc.; and
(3) representing a cognitive speech of cognitive engagement in a classroom by audio-verbal-modal encompassing student's class audio etc., then, jointly representing cognitive speech by two ways of a pre-trained word vector and a word vector with parameters, a representation result is C.

4. The multimodal data-based method for recognizing cognitive engagement in classroom according to claim 3, wherein for visual-behavioral-modal data encompassing student's body posture, head posture and eye movement, features are learned through a You Only Look Once version 8 (Yolov8) model to determine a cognitive behavior engagement mapped by this modal, details are as follows:
(1) data preprocessing
standardizing the size of an input image, aligning the size of an input image to 640×640, and, arranging an input image in a RGB format and a channel-height-width (CHW) format;
(2) backbone layer
extracting features from visual-behavioral-modal data, reducing resolution by four times by continuously using two 3×3 convolutions, the number of convolution channels is 64 and 128, respectively, then, enriching gradient flow with a cross-stage partial feature fusion (c2f) module using branch cross-layer linking;
(3) neck layer and head layer
feeding an output with visual-behavioral features from different stages of a backbone layer into up-sampling, then, combining visual-behavioral feature maps through a decoupling head and an anchor-free mechanism, next, a convolution calculation are performed on behavioral visual-feature maps; and
(4) target detection loss calculation
using a loss calculation comprising a positive-negative sample allocation strategy and a combined loss calculation, a positive-negative sample allocation strategy is selecting a positive sample t according to weights of a classification and a regression by a task alignment strategy;
a calculation is as follows:
$$t = {s}^{α} \times {u}^{β} \qquad ( 1 )$$
s^{α} is a predicted value with a parameter a corresponding to an annotated behavior class, u^{β} is calculated as
$${u}^{β} = \frac{Y ⋂ \hat{Y}}{Y ⋃ \hat{Y}} ;$$
u^{β} indicates a loss with a parameter β between an actual behavior annotation box Y and a predictive behavior box Ŷ of students, a combined loss calculation comprises a classification (CLS) loss and a regression loss, a CLS loss uses a binary cross entropy (BCE) loss calculation mode, a regression loss uses a distribution focal loss (DFL) calculation mode and a complete intersection over union (CIoU) loss (CIL) calculation mode, then, three losses are weighted by a certain weight proportion to obtain a final loss;
1) a CLS value is calculated as follows:
$$CLS = - \frac{1}{M} {\sum }_{i = 1}^{M} ( {Y}_{i} log ( {\hat{Y}}_{i} ) + ( 1 - {Y}_{i} ) log ( 1 - {\hat{Y}}_{i} ) ) \qquad ( 2 )$$
wherein M indicates the number of students in a classroom, Yᵢ is an actual behavior box of an i-th student, Ŷᵢ is a predictive behavior box of an i-th student;
2) a DFL value and a CIL value are calculated as follows:
$$D F L ( {S}_{i} , {S}_{i + 1} ) = - ( ( {Y}_{i} + 1 - Y ) log ( {S}_{i} ) + ( Y - {Y}_{i} ) log ( {S}_{i + 1} ) ) \qquad ( 3 )$$
$$CIL = 1 - ( {u}^{β} - ( loss ( length ) + loss ( width ) ) ) \qquad ( 4 )$$
wherein Si indicates a softmax activation function calculation on this modal features of an i-th student, new features are converted into a probability distribution with a range of [0,1] and 1, loss (length) indicates a loss of a predictive behavior box Ŷand an actual behavior box Y of all students in length, loss (width) indicates a loss of a predictive behavior box Ŷand an actual behavior box Y of all students in width, then, a CLS value, a DFL value and a CIL value of three losses are fused to obtain a final loss.

5. The multimodal data-based method for recognizing cognitive engagement in classroom according to claim 3, wherein for visual-emotional-modal data encompassing student's facial expression etc. are learned through an Efficient Network (EfficientNet) model to determine a cognitive emotion engagement, specific process is as follows:
(1) stage 1: obtaining shallow features of visual-emotional-modal data by a regular convolution calculation with a convolution kernel size of 3*3 and a stride of 2;
(2) stages 2 to 8: outputting deep features of visual-emotional-modal data by repeating a stacked mobile inverted bottleneck convolution (MBConv), MBConv structure mainly expands a dimension of shallow features by a 1*1 regular convolution calculation, the number of convolution kernels is p times of channels of an input feature matrix, p∈{1,6}, then, continuing to extract key features by a q*q depthwise convolution (Conv) and a squeeze-and-excitation (SE) module, next, reducing a dimension of visual-emotional features with facial key features by a 1*1 regular convolution calculation, finally, generating new feature maps of by a droupout layer to prevent overfitting, and
(3) stage 9: outputting a cognitive emotion engagement mapped by visual-emotional-modal data by a composition of a regular convolution operation layer, a maximum pooling layer and a fully connected layer.

6. The multimodal data-based method for recognizing cognitive engagement in classroom according to claim 3, wherein for audio-verbal-modal data encompassing student's class audio and speech text, features in audio-modal data are learned through a Text Convolution Neural Network (TextCNN) model to determine a cognitive speech engagement, specific process is as follows:
(1) a first layer—an input layer: an input is an n*k matrix, n is the number of words in a sentence, k is a dimension corresponding to each word, each row of an input layer is a k-dimensional word vector corresponding to a word;
(2) a second layer—a convolution layer: a regular convolution calculation is used on an input matrix, a convolution kernel is set as w∈R^{kk}, an output is a feature vector c of all sentences, a feature vector cᵢ of each sentence is calculated as follows:
$$\begin{matrix}{c}_{i} = f & ( w \cdot {x}_{i : i + h - 1} + b )\end{matrix} \qquad ( 5 )$$
wherein x_{i:i30 h-1} indicates a window with a size of h*k formed by an i-th row to an i+h−1 row of an input matrix, it is formed by splicing xᵢ, xᵢ₊₁, . . . , xᵢ₊ₕ₋₁, b is a bias parameter, f is a nonlinear activation function;
(3) a third layer—a pooling layer: using a maximum pooling, a K-Max pooling, or an average pooling to further screen a new text feature vector output by the second layer; and
(4) a fourth layer—a fully connected layer and a text classification output: using a fully connected calculation to classify speech data, each class probability of speech data is output through a softmax activation function.

7. The multimodal data-based method for recognizing cognitive engagement in classroom according to claim 1, wherein in step 1, constructing a dataset of cognitive engagement recognition in a classroom based on multimodal data, specific implementation is as follows;
(1) in a classroom environment, led by a teacher who imparts instruction naturally, there are multiple students participating in activities and knowledge construction, a teacher is allowed to fuse advanced technology tools and teaching modes to carry out different class activities;
(2) recording students learning state in a non-invasive and non-perceptive manner, first, mounting a high-definition camera in front of a classroom, then, opening a camera before a class and closes the camera after a class to record a class learning situation in real-time, so we can export recording data from a terminal system as a foundation of a cognitive engagement recognition;
(3) developing a data annotation system to guide manual annotation, during multimodal data annotation, cognitive behavior is annotated using visual-modal data with body postures etc., cognitive emotion is annotated using visual-modal data with facial expressions etc., and cognitive speech is annotated using class audio-modal data with class audio etc., a data annotation system is detailed in FIG. 2;
(4) simultaneously annotating part of the recording data by multiple annotators, carrying out a consultation on inconsistent places, and, annotating the recording data on a large scale;
(5) employing an after-class questionnaire to acquire a genuine cognitive engagement. We use a Likert five-point scoring method as a guidance of multimodal fusion training; and
(6) extracting many video frames to obtain students cognitive engagement state at different granularities, a frame extraction rate is every 25, 50, . . . , or 25*f (f is an integer) frames/time, this condition aligns with a video frame rate of 25 fps, a frame extraction rate is configured to train deep learning models for cognitive engagement.

8. The multimodal data-based method for recognizing cognitive engagement in classroom according to claim 1, wherein in step 4, a recognization of a final cognitive engagement level encompassing a cognitive behavior, a cognitive emotion and a cognitive speech is achieved by following methods:
(1) assuming that three engagement vectors of an i-th student perceived at a moment j are Âⱼ∈Rⁿ¹, \hat{B}ⱼ∈Rⁿ² and Ĉⱼ∈Rⁿ³ respectively, Âj is a cognitive behavior engagement, \hat{B}j is a cognitive emotion engagement, Ĉj indicates a cognitive speech engagement, n₁, n₂ and n₃ indicate feature vectors of three dimensions respectively;
(2) given an educational activity, assuming that F times of real-time engagement recognitions are provided in total in a whole activity, first, training networks of three cognitive engagement states separately, then, calculating Âⱼ, \hat{B}ⱼ, and Ĉⱼ by three deep learning models; and
(3) calculating an overall level Engagementⱼ as follows, where Engagementj is a perceived cognitive engagement of a j-th student at a moment i according to the surveys:
$${Engagement}_{j} = {β}_{1} \cdot {\hat{A}}_{j} + {β}_{2} \cdot {\hat{B}}_{j} + {β}_{3} \cdot {\hat{C}}_{j} \qquad ( 6 )$$
wherein β₁, β₂ and β₃ are three parameters to be learned.

9. A multimodal data-based system for recognizing cognitive engagement in classroom, comprising:
a dataset construction module configured to construct a dataset of student cognitive engagement recognition based on multimodal data in classroom;
a multidimensional representation module configured to obtain three dimensional representation of cognitive engagement concept in classroom;
a multimodal recognition module configured to recognize cognitive behavior, cognitive emotion, and cognitive speech through three deep learning models based on multimodal data respectively, then, output three engagement recognition results; and
a result fusion module configured to fuse three results of different modalities, weights of different modalities are adjusted, and then a decision-making method with weights of cognitive engagement guided by the surveys is trained to output an overall level of cognitive engagement.
